(19) United States
(12) Patent Application Publication
(10) Pub. No.: US 2025/0162882 A1
(43) Pub. Date: May 22, 2025

(54) Silicon Carbide Powder, and Production Method Thereof

(71) Applicant: Tokuyama Corporation, Yamaguchi (JP)

(72) Inventor: Yutaka Fukunaga, Yamaguchi (JP)

(21) Appl. No.: 18/840,717

(22) PCT Filed: Feb. 10, 2023
(86) PCT No.: PCT/JP2023/004556

§ 371 Date: Aug. 22, 2024

(30) Foreign Application Priority Data
Feb. 24, 2022 (JP) 2022-027085

(51) Int. Cl. C01B 32/984

(52) U.S. Cl. CPC C01B 32/984; C01P 2004/61; C01P 2006/12; C01P 2006/40

(57) ABSTRACT

Please delete the Abstract in its entirety and substitute therefor the following new A silicon carbide powder contains free carbon in a content of 0.04 mass % or less, in which a ratio of silicon atoms to carbon atoms (Si/C molar ratio) is 1.00 to 1.02. The silicon carbide powder can be produced by a method including a combustion synthesis step of preheating a mixed powder containing a metal silicon powder and a carbon powder having a Si/C molar ratio of 1.00 or more and 1.02 or less at a temperature of 900° C. to 1300° C. under an inert atmosphere, and igniting a part of the mixed powder to perform combustion synthesis to obtain a crude silicon carbide powder; and a heating step of heating the crude silicon carbide powder at a temperature of 2000° C. to 2500° C. under an inert atmosphere. In addition, the silicon carbide powder can also be obtained, without undergoing the heating step, by preheating the mixed powder at a temperature of 900° C. to 1300° C. under an atmospheric pressure and an inert atmosphere, and igniting a part of the mixed powder to perform combustion synthesis.

### TECHNICAL FIELD

The present invention relates to a silicon carbide powder and a method for producing a silicon carbide powder.

### BACKGROUND ART

Silicon carbide (SiC) has excellent properties such as high hardness, high strength, high heat resistance, and high thermal conductivity, and thus has been used as an abrasive, a refractory, a heating element, and the like. In recent years, a demand for SiC as a raw material for a SiC semiconductor wafer has also increased. A silicon carbide powder suitable for these applications has been produced, and particularly a high-purity silicon carbide powder is required for the raw material for a SiC semiconductor wafer and a raw material of a SiC sintered body for a semiconductor production application or the like. It is known that a cause of a decrease in purity of the silicon carbide powder is unreacted silicon and carbon derived from a raw material for the production, and when a silicon carbide powder containing the unreacted silicon and carbon is used as a raw material, a resulting product is adversely influenced. For example, Patent Literature 1 discloses that when unreacted carbon (free carbon) is contained in a raw material silicon carbide powder for producing a SiC single crystal by a sublimation recrystallization method, the unreacted carbon is incorporated into the SiC single crystal to cause defect generation. In addition, Patent Literature 2 discloses that when free Si is contained in a raw material silicon carbide powder for producing a silicon carbide sintered body, sintering is inhibited or defects are generated in the sintered body.

Known methods for producing silicon carbide include: (1) an Acheson method in which silica sand and coke are heated at a higher temperature by electrical heating (for example, Patent Literatures 1 and 3); (2) a method in which a mixture containing silica and a carbon powder is externally heated to be reduced and subjected to a carbonization reaction (for example, Patent Literature 4); (3) a method in which a mixture containing a metal silicon powder and a carbon powder is externally heated to be carbonized (for example, Patent Literature 5); and (4) a method in which a mixture containing a metal silicon powder and a carbon powder is preheated and then a part of a sample is ignited and combusted (for example, Patent Literature 6).

The method (1) is the most common method for producing a silicon carbide powder, and the silicon carbide powder can be produced relatively inexpensively using large-scale equipment; however, since there is temperature variation in a furnace, free Si and free carbon are likely to be generated, making it difficult to obtain a high-purity product. In the production method (2), by using high-purity silica and a carbon powder as a raw material, a silicon carbide powder having a relatively high purity is easily obtained, but silica is used as a raw material, and free SiO₂ tends to be generated. In the production method (3), by using a high-purity metal silicon powder and a carbon powder as a raw material, a silicon carbide powder having a relatively high purity is easily obtained, but Si is volatilized during high-temperature firing, and an amount of free carbon cannot be sufficiently reduced. In the production method (4), synthesis can be performed at a lower temperature than in the production method (3), and therefore volatilization of Si can be prevented; however, since a reaction temperature is low, a conversion rate to silicon carbide is reduced, resulting in a large amount of unreacted silicon and free carbon.

In addition, for example, as described in Patent Literatures 1 and 4, it has been attempted to improve the purity by removing impurities from the produced silicon carbide powder, but there is a limit to improvement of the purity.

### CITATION LIST

### Patent Literature

Patent Literature 1: Japanese Patent Laid-Open No. 2019-151533
Patent Literature 2: Japanese Patent Laid-Open No. S63-17258
Patent Literature 3: Japanese Patent Laid-Open No. 2015-157737
Patent Literature 4: Japanese Patent Laid-Open No. 2012-246165
Patent Literature 5: WO2012-157293
Patent Literature 6: Japanese Patent Laid-Open No. S53-25300

### SUMMARY OF INVENTION

### Technical Problem

As described above, there is a demand for a silicon carbide powder containing small amounts of Si-based impurities, such as unreacted silicon and free SiO₂, and free carbon, but the silicon carbide powder in which both amounts of the Si-based impurities and free carbon are sufficiently reduced has not been obtained so far. Therefore, an object of the present invention is to provide a silicon carbide powder in which both amounts of Si-based impurities and free carbon are sufficiently reduced.

### Solution to Problem

As a result of intensive studies to solve the above problems, the present inventors have found that a high-purity silicon carbide powder in which both amounts of Si-based impurities and free carbon are reduced to a level that cannot be realized by a conventional method can be obtained by using a mixed powder obtained by mixing a metal silicon powder and a carbon powder at a specific ratio as a raw material, preheating the mixed powder at a low temperature, performing a combustion synthesis reaction, and then reacting an unreacted portion by heating at a high temperature. Thus, the present invention has been completed.

That is, the present invention provides a silicon carbide powder containing free carbon in a content of 0.04 mass % or less, in which a ratio of silicon atoms to carbon atoms (Si/C molar ratio) is 1.00 to 1.02. In the silicon carbide powder, an amount of metal impurities is preferably 200 ppm or less.

In addition, the present invention provides a method for producing a silicon carbide powder, including: a combustion synthesis step of preheating a mixed powder containing a metal silicon powder and a carbon powder having a Si/C molar ratio of 1.00 or more and 1.02 or less at a temperature of 900° C. to 1300° C. under an inert atmosphere, and then igniting a part of the mixed powder to perform combustion synthesis to obtain a crude silicon carbide powder; and a heating step of heating the crude silicon carbide powder at a temperature of 2000° C. to 2500° C. under an inert atmosphere.

Further, the present invention provides a method for producing a silicon carbide powder, including: a combustion synthesis step of preheating a mixed powder containing a metal silicon powder and a carbon powder having a Si/C molar ratio of 1.00 or more and 1.02 or less at a temperature of 900° C. to 1300° C. under an atmospheric pressure and an inert atmosphere, and then igniting a part of the mixed powder to perform combustion synthesis to obtain a silicon carbide powder.

### Advantageous Effects of Invention

According to the present invention, a high-purity silicon carbide powder containing small amounts of Si-based impurities and free carbon can be obtained. As a result, when the high-purity silicon carbide powder is used as a raw material for a SiC single crystal produced by a sublimation recrystallization method, a single crystal with few defects can be produced. In addition, when the high-purity silicon carbide powder is used as a raw material for a sintered body, a sintered body having good sinterability and few defects can be produced.

### DESCRIPTION OF EMBODIMENTS

### <Silicon Carbide Powder>

A silicon carbide powder of the present invention contains 0.04 mass % or less of free carbon. When the free carbon is 0.04 mass % or less, the silicon carbide powder can be particularly suitably used for a semiconductor application which requires a high purity. The amount of free carbon is preferably 0.02 mass % or less, and more preferably 0.01 mass % or less. The amount of free carbon can be measured according to a combustion-weight correction method at 850° C. in JISR1616:2007.

The silicon carbide powder of the present invention has a Si/C molar ratio of 1.00 or more and 1.02 or less. In the silicon carbide powder, carbon atoms are present as silicon carbide or free carbon. As in the silicon carbide powder of the present invention, since the free carbon is 0.04 mass % or less, most of the carbon atoms are present as silicon carbide. Therefore, Si/C being within the above range means that there are few silicon atoms (that is, Si-based impurities) other than those in silicon carbide. The Si/C molar ratio is more preferably 1.00 or more and 1.01 or less. The Si/C molar ratio can be calculated based on a ratio of a total amount of silicon measured by dehydrated weight ICP emission spectroscopy (JISR1616:2007) to a total amount of carbon measured by a combustion (resistance heating)-infrared absorbing method (JISR1616:2007).

The silicon carbide powder of the present invention preferably has an average particle diameter of 0.5 μm to 50.0 μm, and more preferably 1.0 μm to 35.0 μm. The particle diameter can be measured by a laser diffraction and scattering method. The silicon carbide powder of the present invention preferably has a specific surface area of 0.2 m²/g to 3.0 m²/g. The specific surface area can be measured by a gas adsorption method. An amount of metal impurities in the silicon carbide powder of the present invention is preferably 200 ppm or less, more preferably 100 ppm or less, and still more preferably 50 ppm or less. When the amount of the metal impurities is small, the silicon carbide powder can be particularly suitable for a semiconductor application which particularly requires a high purity. The amount of the metal impurities can be measured by glow discharge mass spectrometry. The amount of the metal impurities is a total amount of alkali metals, alkaline earth metals, transition metals, zinc, cadmium, and mercury with the atomic numbers of 3 to 92.

### <Method for Producing Silicon Carbide Powder>

The silicon carbide powder of the present invention can be simply produced by a method for producing a silicon carbide powder, the method including: a combustion synthesis step of preheating a mixed powder containing a metal silicon powder and a carbon powder having a Si/C molar ratio of 1.00 or more and 1.02 or less at a temperature of 900° C. to 1300° C. under an inert atmosphere, and then igniting a part of the mixed powder to perform combustion synthesis to obtain a crude silicon carbide powder; and a heating step of heating the crude silicon carbide powder at a temperature of 2000° C. to 2500° C. under an inert atmosphere. Hereinafter, this production method will be described.

### [Mixed Powder]

In the production method of the present invention, the mixed powder containing the metal silicon powder and the carbon powder having a Si/C molar ratio of 1.00 or more and 1.02 or less is used. As will be described later, in the production method, since almost all Si is bonded to carbon and converted into silicon carbide in the combustion synthesis step and the heating step, the Si/C molar ratio of the produced silicon carbide powder can be set in a range of 1.00 to 1.02 by using the mixed powder containing the metal silicon powder and the carbon powder having a Si/C molar ratio of 1.00 or more and 1.02 or less as a raw material. When the Si/C molar ratio is less than 1.00, the free carbon is easily generated, and when the Si/C molar ratio is more than 1.02, the Si-based impurities are easily generated.

The metal silicon powder preferably has a particle diameter of 2.0 μm to 50.0 μm, and more preferably 4.0 μm to 35.0 μm. When the particle diameter is smaller than this range, a proportion of a surface oxide film increases, and therefore there is a concern that amounts of the Si-based impurities and the free carbon in the silicon carbide powder increase. When the particle diameter is larger than this range, there is a concern that it is difficult to uniformly mix the metal silicon powder with the carbon powder, a reaction rate is not sufficiently high, and the amounts of the Si-based impurities and the free carbon increase. When the metal silicon contains metal impurities, since a metal impurity concentration in the silicon carbide powder also tends to be high, it is preferable to use the metal silicon powder having a purity of 99.9999999% or more, more preferably 99.99999999% or more, and still more preferably 99.999999999% or more.

In particular, focusing on B, Al, Fe, Cu, Mg, Ni, and Ca, which are metal impurities considered to have a bad influence on a SiC semiconductor wafer, it is possible to minimize the influence of the metal impurities on the silicon carbide powder. A total content of these metal impurities is preferably 1 ppm or less, and more preferably 0.1 ppm or less.

The carbon powder preferably has a particle diameter of 10 nm or more and 1 μm or less. When the particle diameter is smaller than this range, there is a concern that air and moisture are easily adsorbed, and a purity of the silicon carbide powder is reduced. When the particle diameter is larger than this range, there is a concern that it is difficult to uniformly mix the carbon powder with the metal silicon powder, the reaction rate is not sufficiently high, and the amounts of the Si-based impurities and the free carbon increase. When the carbon powder contains metal impurities, since the metal impurity concentration in the silicon carbide powder also tends to be high, a metal impurity concentration in the carbon powder is preferably 50 ppm or less, more preferably 10 ppm or less, and still more preferably 5 ppm or less. The type of the carbon powder is not particularly limited, and for example, carbon black or graphite can be used. The carbon black can be used which was produced in various production methods such as a furnace method (furnace black), a channel method (channel black), and an acetylene method (acetylene black).

A method of mixing the metal silicon powder and the carbon powder to obtain the mixed powder is not particularly limited as long as the metal silicon powder and the carbon powder can be mixed to obtain a desired Si/C molar ratio, and for example, it is sufficient that the metal silicon powder and the carbon powder is weighed to obtain a desired amount, and are uniformly mixed using a known mixing method.

The method of mixing the metal silicon powder and the carbon powder is not particularly limited, and for example, mixing using a blender, a mixer, or a ball mill can be exemplified as a preferred method. A method in which a raw material is subjected to a load during mixing such as mixing using a ball mill, is more preferred since homogeneity of the metal silicon powder and the carbon powder is improved. A material of a vessel, a ball, and the like to be filled with the metal silicon powder and the carbon powder is preferably a material not easily mixed into the raw material due to abrasion during the mixing, and is more preferably high-purity silicon carbide. In addition, in a case of a method in which a raw material is subjected to a load during mixing such as mixing using a ball mill, when mixing is performed in the presence of oxygen, there is a concern that a fresh surface of metal silicon is oxidized to increase the amounts of the Si-based impurities and the free carbon in the silicon carbide powder, and therefore, it is preferable to prevent oxidation by performing mixing in a non-oxidizing atmosphere (in particular, in a rare gas atmosphere such as argon) and taking out the mixture after cooling to room temperature.

In addition to the metal silicon powder and the carbon powder, a silicon carbide powder may be added as a diluent to the mixed powder for the purpose of controlling a reaction temperature or the like, as long as an effect of the present invention is not impaired. When the silicon carbide powder is used as the diluent, the Si/C molar ratio of the mixed powder is adjusted by taking into account of silicon and carbon contained in the silicon carbide powder as the diluent. A blending amount of the silicon carbide powder is generally 50 mass % or less of the mixed powder. In addition, when the silicon carbide powder contains a large amount of metal impurities, an amount of the metal impurities in the produced silicon carbide powder is also large, so that the silicon carbide powder as the diluent contains a metal impurities in an amount of preferably 200 ppm or less, more preferably 100 ppm or less, and still more preferably 50 ppm or less. The silicon carbide powder produced by the production method of the present invention may be used as the diluent.

### [Combustion Synthesis Step]

In the production method of the present invention, the combustion synthesis step is performed in which the mixed powder is preheated at a temperature of 900° C. to 1300° C. under an inert atmosphere, and then a part of the mixed powder is ignited to combust the entire mixed powder by self-propagation. Accordingly, a crude silicon carbide powder containing a silicon carbide powder synthesized by the combustion synthesis, and the metal silicon powder and the carbon powder remaining unreacted in the combustion synthesis is obtained.

In this step, the inert atmosphere can be, for example, a rare gas such as helium, neon, or argon. A pressure is not particularly limited, and is preferably 500 Pa or less, more preferably 100 Pa or less, and still more preferably 20 Pa or less. By setting the pressure within the above range, nitrogen, moisture, and low-boiling-point substances adsorbed to the raw material can be easily removed. A lower limit of the pressure is not particularly limited, and is sufficiently, for example, 0.5 Pa or more. In the case of setting the inside of a reaction vessel to an inert atmosphere after the raw material is placed in the reaction vessel, it is preferable to perform, once or more of a step of reducing the pressure inside the reaction vessel to 0.5 Pa or more and 10 Pa or less, then introducing an inert gas, and restoring the pressure to a predetermined pressure.

In addition, in a case where the step of reducing the pressure inside the reaction vessel to 0.5 Pa or more and 10 Pa or less, then introducing an inert gas, and restoring the pressure to a predetermined pressure is performed twice or more, the pressure during preheating and/or combustion synthesis can be a normal pressure (atmospheric pressure). When the combustion synthesis step is performed under a normal pressure, volatilization of a Si content is prevented, and thus a silicon carbide powder having a free carbon content of 0.04 mass % or less can be obtained after the combustion synthesis step. In the case, a heating step to be described later may be omitted.

A preheating temperature is 900° C. to 1300° C., and preferably 1000° C. to 1200° C. By setting the preheating temperature to 900° C. or higher, an amount of unreacted metal silicon in the crude silicon carbide powder can be reduced, volatilization of the metal silicon in the subsequent combustion synthesis step can be prevented, and the Si/C molar ratio of the silicon carbide powder can be adjusted to a desired value. On the other hand, when the preheating temperature is too high, a combustion temperature during the combustion synthesis is high, and it is difficult to adjust the Si/C molar ratio of the silicon carbide powder to a desired value.

The preheating method is not particularly limited, and for example, it is sufficient that the mixed powder charged into a heat-resistant reaction vessel made of ceramics, graphite, or the like is placed in a firing furnace, the atmosphere is adjusted, and then a temperature in the firing furnace is increased from room temperature to a preheating temperature. A heating-up rate is not particularly limited, and the heating-up is preferably performed over 1 hour or longer since the heating is likely to be uniformly performed. An upper limit of the heating-up time is not particularly limited, and is preferably 24 hours or shorter from the viewpoint of efficient production. After the temperature is increased to the preheating temperature, the combustion synthesis reaction may be started by ignition immediately, or the combustion synthesis reaction may be started by ignition after the temperature is maintained at the preheating temperature for a while. When the combustion synthesis reaction is started by ignition after the temperature is maintained at the preheating temperature for a while, the maintaining time at the preheating temperature is preferably within 24 hours from the viewpoint of efficient production.

A condition of the combustion synthesis reaction in the present invention is not particularly limited, and it is sufficient that an ignition method is performed by a known method.

### [Heating Step]

In the production method of the present invention, a heating step of heating the crude silicon carbide powder obtained in the combustion synthesis step at 2000° C. to 2500° C. under an inert atmosphere may be performed.

In general, at 2000° C. or higher, a reaction between the metal silicon powder and the carbon powder is promoted, and almost all of the powders can be reacted, but at the same time, since the metal silicon volatilizes, the Si/C molar ratio of the produced silicon carbide powder is greatly different from a blending ratio in the raw material. However, in the production method of the present invention, since most of the metal silicon is converted into silicon carbide in advance in the combustion synthesis step, an amount of the metal silicon heated at a high temperature is reduced and the volatilization of the metal silicon is prevented as compared with a case where a mixture containing the metal silicon and the carbon powder is heated at a high temperature. Therefore, it is possible to obtain a silicon carbide powder having a Si/C molar ratio equivalent to that in the raw material while substantially completely consuming the carbon powder by the reaction. In addition, in the heating step, the metal silicon and the carbon powder are diluted with silicon carbide produced in the combustion synthesis step. This is also advantageous to prevent the volatilization of the metal silicon, since the heat generated by the production of silicon carbide is diffused to surroundings and an actual temperature is prevented from increasing more than the setting temperature of the firing furnace. Accordingly, intended silicon carbide powder having a free carbon content of 0.04 mass % or less and a Si/C molar ratio of 1.00 to 1.02 can be obtained.

In the heating step, the crude silicon carbide powder that has been heated in the combustion synthesis step may be directly heated continuously, or may be cooled once after the combustion synthesis step and then heated again, and it is preferable to perform the heating step continuously since this reduces energy required for heating.

In the heating step, the inert atmosphere can be, for example, a rare gas such as helium, neon, or argon. A pressure is not particularly limited, and is preferably 500 Pa or less, more preferably 100 Pa or less, and still more preferably 20 Pa or less. By setting the pressure within the above range, nitrogen, moisture, and low-boiling-point substances adsorbed to the raw material can be easily removed. A lower limit of the pressure is not particularly limited, and is preferably, for example, 0.5 Pa or more. When the combustion synthesis step and the heating step are not continuously performed, it is preferable to perform, once or more of a step of reducing the pressure inside the reaction vessel to 0.5 Pa or more and 10 Pa or less, then introducing an inert gas, and restoring the pressure to a predetermined pressure.

A temperature in the heating step is 2000° C. or higher and 2500° C. or lower, preferably 2050° C. or higher and 2400° C. or lower, and more preferably 2100° C. or higher and 2300° C. or lower. As described above, by setting the heating temperature to 2000° C. or higher, the unreacted metal silicon powder and carbon powder in the crude silicon carbide powder may be sufficiently reacted, and the amounts of the Si-based impurities and the free carbon may be sufficiently reduced. When the temperature in the heating step is higher than 2500° C., the volatilization of the metal silicon powder in the crude silicon carbide powder occurs, the Si/C molar ratio cannot be adjusted to a desired value, and the amount of the free carbon tends to increase.

A heating time is not particularly limited, and is maintained until the unreacted metal silicon powder and carbon powder in the crude silicon carbide powder obtained in the combustion synthesis step react with each other and are completely consumed, and can be, for example, 1 to 10 hours.

### [Pulverization Step]

In the production method of the present invention, pulverization may be performed after the heating step, if necessary, to adjust the particle diameter. The pulverization method is not particularly limited, and for example, pulverization using a vibrating ball mill, a rotating ball mill, or a jet mill can be exemplified as a preferred method. A material of a vessel, a ball, and the like is preferably a material not easily mixed into the raw material due to abrasion, and is more preferably high-purity silicon carbide. Even when impurities are mixed, the impurities can be removed in a cleaning step to be described later.

### [Cleaning Step]

In the production method of the present invention, a cleaning treatment may be performed in order to reduce the amount of the metal impurities and the like, if necessary. An acid aqueous solution or an alkali aqueous solution can be used for cleaning, and the solution is appropriately selected according to an element to be reduced. Examples of the acid aqueous solution include hydrochloric acid, hydrofluoric acid, nitric acid, sulfuric acid, and phosphoric acid, and examples of the alkali aqueous solution include a sodium hydroxide aqueous solution and a potassium hydroxide aqueous solution. If necessary, the cleaning solution may be heated to promote dissolution.

### <Application of Silicon Carbide Powder>

An application of the silicon carbide powder of the present invention is not particularly limited. The silicon carbide powder contains small amounts of Si-based impurities and free carbon, and can thus be particularly suitably used as a raw material for a SiC single crystal produced by a sublimation recrystallization method or a raw material for a SiC sintered body for production of a semiconductor or the like, which requires a particularly high-purity silicon carbide powder.

### EXAMPLES

The present invention will be described in more detail below, but the present invention is not limited to these Examples. Various physical properties in Examples and Comparative Examples were measured by the following methods.

### (1) Si/C Molar Ratio

The total amount of silicon was measured by dehydrated weight ICP emission spectroscopy using ICP-OES (iCAP6500DUO manufactured by Thermo Fischer Scientific) according to JISR1616:2007, the total amount of carbon was measured by combustion (resistance heating)-infrared absorbing method using a carbon and sulfur analyzer (EMIA-Step manufactured by HORIBA), and the Si/C molar ratio was calculated based on the obtained results.

### (2) Free Carbon Content

Using a carbon and sulfur analyzer (EMIA-Step manufactured by HORIBA), the free carbon content was measured according to a combustion-weight correction method at 850° C. in JISR1616:2007.

### (3) Metal Impurity

As for the amount of metal impurities, the total amount of alkali metals, alkaline earth metals, transition metals, zinc, cadmium, and mercury with the atomic numbers of 3 to 92 was measured by glow discharge mass spectrometry.

### (4) Particle Diameter (Average Particle Diameter D50)

The average particle diameter was measured by a laser diffraction particle diameter distribution device.

### (5) Specific Surface Area

The specific surface area was determined by a BET method by nitrogen adsorption using a gas adsorption measuring device.

### Example 1

A metal silicon powder having an average particle diameter of 5.1 μm and a purity of 99.999999999% and acetylene black having an average particle diameter of 30 nm and a metal impurity concentration of 30 ppm as a carbon powder were weighed at a molar ratio of 1.01:1.00 (Si/C molar ratio: 1.01), and mixed using a planetary ball mill to obtain a mixed powder. An atmosphere during the mixing was argon, and after cooling, argon was replaced with air. A material of the ball and a pot was silicon carbide.

The mixed powder was charged into a graphite crucible and placed in a firing furnace. The pressure in the furnace was reduced to 0.5 Pa or more and 10 Pa or less, then argon having a purity of 99.99% was introduced to restore the pressure to a normal pressure, and the pressure was reduced again to 0.5 Pa or more and 20 Pa or less. While maintaining a degree of vacuum of 0.5 Pa or more and 20 Pa or less, the temperature was increased from room temperature to 1200° C. over 3 hours for preheating. Immediately after the temperature reached 1200° C., a part of the mixed powder was energized and ignited to obtain a crude silicon carbide powder by a combustion synthesis reaction. After confirming that the combustion synthesis reaction was completed, heating was performed at 2200° C. for 5 hours while maintaining the pressure of 0.5 Pa or more and 20 Pa or less.

An evaluation result for the obtained silicon carbide powder is shown in Table 1.

### Example 2

The silicon carbide powder produced by the method in Example 1 was pulverized using a planetary ball mill. A material of the ball and a pot was silicon carbide. An evaluation result for the obtained silicon carbide powder is shown in Table 1.

### Example 3

A silicon carbide powder was synthesized in the same manner as in Example 1 except that the preheating temperature in the combustion synthesis step was set to 1000° C. An evaluation result for the obtained silicon carbide powder is shown in Table 1.

### Example 4

A silicon carbide powder was synthesized in the same manner as in Example 1 except that a metal silicon powder having an average particle diameter of 30.2 μm and a purity of 99.999999999% was used as a raw material. An evaluation result for the obtained silicon carbide powder is shown in Table 1.

### Example 5

A metal silicon powder having an average particle diameter of 5.0 μm and a total amount of metal impurities of B, Al, Fe, Cu, Mg, Ni, and Ca of 0.51 ppm and acetylene black having an average particle diameter of 30 nm and a total amount of metal impurities of B, Al, Fe, Cu, Mg, Ni, and Ca of 1.5 ppm as a carbon powder were weighed at a molar ratio of 1.01:1.00 (Si/C molar ratio: 1.01) and mixed using a ball mill to obtain a mixed powder. An atmosphere during the mixing was argon, and after cooling, argon was replaced with air. A material of the ball and a pot was silicon carbide.

The mixed powder was charged into a graphite crucible and placed in a firing furnace. An operation of reducing the pressure in the furnace to 0.5 Pa or more and 10 Pa or less, then introducing argon having a purity of 99.99%, and restoring the pressure to a normal pressure was repeated twice. While maintaining the atmospheric pressure, argon was allowed to flow through an electric furnace at a flow rate of 5 L/min, and preheating was performed from room temperature to 1200° C. over 3 hours. Immediately after the temperature reached 1200° C., a part of the mixed powder was energized and ignited to obtain a silicon carbide powder by a combustion synthesis reaction. An evaluation result for the obtained silicon carbide powder is shown in Table 1.

### Example 6

Combustion synthesis was performed in the same manner as in Example 5. After the combustion synthesis was completed, the pressure inside the firing furnace was reduced to 0.5 Pa or more and 20 Pa or less, and heating was performed at 2200° C. for 5 hours while maintaining the pressure. An evaluation result for the obtained silicon carbide powder is shown in Table 1.

### Comparative Example 1

A silicon carbide powder was synthesized in the same manner as in Example 1 except that the preheating temperature in the combustion synthesis step was set to 700° C. An evaluation result for the obtained silicon carbide powder is shown in Table 1.

### Comparative Example 2

A silicon carbide powder was synthesized in the same manner as in Example 1 except that the preheating temperature in the combustion synthesis step was set to 1400° C. An evaluation result for the obtained silicon carbide powder is shown in Table 1.

### Comparative Example 3

A silicon carbide powder was synthesized in the same manner as in Example 1 except that the temperature in the heating step was set to 1800° C. An evaluation result for the obtained silicon carbide powder is shown in Table 1.

### Comparative Example 4

A silicon carbide powder was synthesized in the same manner as in Example 1 except that the temperature in the heating step was set to 2600° C. An evaluation result for the obtained silicon carbide powder is shown in Table 1.

### Comparative Example 5

A silicon carbide powder was synthesized in the same manner as in Example 1 except that the ratio of the metal silicon powder to acetylene black in the mixed powder was 1.00:1.05 (Si/C ratio: 0.95). An evaluation result for the obtained silicon carbide powder is shown in Table 1.

### Comparative Example 6

A silicon carbide powder was synthesized in the same manner as in Example 1 except that the ratio of the metal silicon powder and acetylene black in the mixed powder was 1.05:1.00 (Si/C ratio: 1.05). An evaluation result for the obtained silicon carbide powder is shown in Table 1.

### Comparative Example 7

After a mixed powder was obtained using a ball mill in the same manner as in Example 5, the mixed powder was charged into a graphite crucible and placed in a firing furnace. The pressure in the furnace was reduced to 0.5 Pa or more and 10 Pa or less, then argon having a purity of 99.99% was introduced to restore the pressure to a normal pressure, and the pressure was reduced again to 0.5 Pa or more and 20 Pa or less. While maintaining a degree of vacuum of 0.5 Pa or more and 20 Pa or less, the temperature was increased from room temperature to 1200° C. over 3 hours for preheating. Immediately after the temperature reached 1200° C., a part of the mixed powder was energized and ignited to obtain a silicon carbide powder by a combustion synthesis reaction. An evaluation result for the obtained silicon carbide powder is shown in Table 1.

TABLE 1

| | Si/C | Free | Metal | Average | Specific |
|---|---|---|---|---|---|
| | molar | carbon | impurity | particle | surface |
| | ratio | content | content | diameter | area |
| | — | [mass %] | [ppm] | [μm] | [m²/g] |
| Example 1 | 1.01 | 0.01 | 24 | 15.1 | 0.3 |
| Example 2 | 1.01 | 0.01 | 30 | 1.6 | 2.5 |
| Example 3 | 1 | 0.02 | 24 | 14.2 | 0.5 |
| Example 4 | 1.01 | 0.02 | 25 | 32.1 | 0.3 |
| Comparative | 1 | 0.06 | 26 | 12.2 | 0.5 |
| Example 1 | | | | | |
| Comparative | 1 | 0.07 | 27 | 15.5 | 0.4 |
| Example 2 | | | | | |
| Comparative | 1.02 | 0.05 | 40 | 14.5 | 0.4 |
| Example 3 | | | | | |
| Comparative | 1 | 0.08 | 20 | 16.1 | 0.4 |
| Example 4 | | | | | |
| Comparative | 0.94 | 0.3 | 25 | 14.3 | 0.4 |
| Example 5 | | | | | |
| Comparative | 1.04 | 0.01 | 25 | 14.7 | 0.5 |
| Example 6 | | | | | |
| Example 5 | 1.01 | 0.01 | 0.5 | 13.7 | 0.4 |
| Example 6 | 1.01 | 0.01 | 0.5 | 15.5 | 0.3 |
| Comparative | 1.01 | 0.1 | 0.5 | 12.5 | 0.5 |
| Example 7 | | | | | |

1. A silicon carbide powders comprising:
free carbon in a content of 0.04 mass % or less,
wherein a ratio of silicon atoms to carbon atoms (Si/C molar ratio) is 1.00 to 1.02.

2. The silicon carbide powder according to claim 1, wherein an amount of metal impurities is 200 ppm or less.

3. A method for producing a silicon carbide powder, comprising:
a combustion synthesis step of preheating a mixed powder containing a metal silicon powder and a carbon powder having a Si/C molar ratio of 1.00 or more and 1.02 or less at a temperature of 900° C. to 1300° C. under an inert atmosphere, and then igniting a part of the mixed powder to perform combustion synthesis to obtain a crude silicon carbide powder; and
a heating step of heating the crude silicon carbide powder at a temperature of 2000° C. to 2500° C. under an inert atmosphere.

4. A method for producing a silicon carbide powder, comprising:
a combustion synthesis step of preheating a mixed powder containing a metal silicon powder and a carbon powder having a Si/C molar ratio of 1.00 or more and 1.02 or less at a temperature of 900° C. to 1300° C. under an atmospheric pressure and an inert atmosphere, and
then igniting a part of the mixed powder to perform combustion synthesis to obtain a silicon carbide powder.
